(19) United States
(12) Patent Application Publication
(10) Pub. No.: US 2025/0032355 A1
(43) Pub. Date: Jan. 30, 2025

(54) Medical Supporting Device

(71) Applicant: Bryan Jones, Wichita, KS (US)

(72) Inventor: Bryan Jones, Wichita, KS (US)

(21) Appl. No.: 18/751,498

(22) Filed: Jun. 24, 2024

Related U.S. Application Data
(60) Provisional application No. 63/515,569, filed on Jul. 25, 2023.

(51) Int. Cl. A61H 31/00

(52) U.S. Cl. CPC A61H 31/008; A61H 2201/0107; A61H 2201/1614; A61H 2201/1623; A61H 2201/169; A61H 2203/0456; A61H 2205/062; A61H 2205/081

(57) ABSTRACT

A medical support device for management of the airway of a patient is disclosed. An example of the medical support devices includes a bottom surface, an upper surface, first and second inclined sidewall surfaces, the first inclined sidewall surface adjoining the bottom surface and the upper surface, the second inclined sidewall surface adjoining the bottom surface and the upper surface, the upper surface being located transversely between the first and second inclined sidewall surfaces. The first inclined sidewall surface, the upper surface, and the second inclined sidewall surface are collectively configured to orient a chest airway region of a patient into an open position when the patient is oriented in a supine position with the upper surface of the medical device positioned beneath the thoracic spine region of the patient.

### CROSS-REFERENCE TO RELATED APPLICATIONS

This application claims the benefit of U.S. Provisional Patent Application No. 63/515,569, filed Jul. 25, 2023, which is hereby incorporated by reference in its entirety.

### FIELD

This disclosure generally pertains to the field of emergency medical devices and services. More specifically, the disclosure relates to a medical supporting device that facilitates air movement and/or oxygen administration for a patient in an emergency setting in need of resuscitation.

### BACKGROUND

In the United States, there are approximately 350,000 resuscitation attempts that occur outside of a hospital setting each year, amounting to almost 1,000 per day according to the American Heart Association. Both inside and outside of hospitals, about 436,000 Americans die from cardiac arrest per year. Those in need of resuscitation range in age, from young children and newborns to elderly adults. Inside hospitals, cardiac arrest incidents have a higher chance of recovery. Thus, only about 36% of in-hospital incidents result in a fatality. However, those who experience out-of-hospital cardiac arrests have a significantly lower chance of receiving the help they need, resulting in a 60% chance of mortality or other life-changing health conditions.

In emergency medical situations, patient oxygen movement and administration is a vital component to keeping people alive. It takes merely minutes without oxygen for the brain and other organs throughout the body to suffer irreversible damage. The brain and cardiac system simply cannot function without oxygen.

In today's world a large percentage of the population has difficulty breathing or an ineffective patent airway while laying supine, specifically while unconscious. Examples of this population include obese, sleep apnea, heavy chested, and other patients with irregularly proportioned airways. Examples also include patients with disproportionately large heads, such as children and infants. These patients often present with gurgling or snoring sounds, indicating ineffective airway movement. Many don't move air at all while laying on their back. Thus, the airway is essentially clogged or kinked due to patient positioning or anatomical structure.

One of the biggest challenges is quickly and easily placing the patient in a position which is optimal for patent airway movement or oxygen administration. The patient may be unconscious or not breathing. Ideal patient positioning while supine often includes head tilt chin lift or jaw thrust to facilitate an open airway, for air movement. The recovery position is another option commonly utilized in EMS for patient positioning to preserve a patent airway in unconscious patients. Another commonly used method nationwide in EMS is improvising on scene using a blanket or towel to prop up a child or infant due to disproportionately large head size negatively affecting air movement in the supine position.

All of these methods are fairly inconsistent, require man power and a team member's active attention.

Due to the above issues and the current deficiencies in the art, a size-adjustable support for creating and maintaining an optimal patient Cardiopulmonary Resuscitation (CPR) position is needed to allow a single user to more easily administer lifesaving care to a patient experiencing a cardiac arrest emergency in an out-of-hospital setting.

### SUMMARY

The disclosure provides various embodiments of a medical supporting device to orient the chest airway region of person experiencing unconsciousness or difficulty breathing as is often encountered by emergency medical responders. The base portion of the medical support device may be positioned beneath the thoracic spine region of the patient. The configuration of the device orients the chest of the patient into an open position which is conducive to improving the breathing conditions of the patient.

In one aspect, a medical support device is disclosed. The medical support device comprises a bottom surface configured to support the device and a sidewall surface extending upwardly from the bottom surface to a truncated upper surface, the truncated upper surface establishing an upper patient-supporting surface.

In another aspect, a medical support device for airway management is disclosed. The medical support device comprises a sagittal axis located within a median sagittal plane, a transverse axis located within a median transverse plane, and a base portion. The base portion comprises a bottom surface having a bottom surface width and a bottom surface length, an upper surface opposite the bottom surface and having an upper surface width and an upper surface length, and first and second inclined sidewall surfaces. The upper surface width is less than the bottom surface width, and the upper surface width is less than the upper surface length. The first inclined sidewall surface adjoins the bottom surface at a first bottom edge and adjoins the upper surface at a first upper edge. The second inclined sidewall surface adjoins the bottom surface at a second bottom edge and the upper surface at a second upper edge. The upper surface is located transversely between the first and second inclined sidewall surfaces. Collectively, the first inclined sidewall surface, the upper surface, and the second inclined sidewall surface are configured to orient a chest airway region of a patient into an open position when said patient is oriented in a supine position with the upper surface of the medical device positioned beneath a thoracic spine region of the patient.

In some aspects, the medical support device further comprises a shoulder portion. The shoulder portion comprises a bottom surface, the bottom surface having a bottom surface width and a bottom surface length, and an upper surface, the upper surface being opposite the bottom surface and having an upper surface width and an upper surface length, wherein the upper surface width is greater than the upper surface length. The upper surface of the base portion and the upper surface of the shoulder portion collectively form a T-shaped support surface.

In another aspect, a method of managing an airway of a patient is disclosed. The method comprises placing a medical support device on a level surface, orienting the medical support device, and positioning the patient onto the medical support device in a supine position. The medical support device comprises a base portion having a bottom surface, an upper surface opposite the bottom surface, and first and second inclined sidewall surfaces. The bottom surface has a bottom surface width, and the upper surface has an upper surface width, wherein the upper surface width is less than the bottom surface width. The first inclined sidewall surface adjoins the bottom surface at a first bottom edge and the upper surface at a first upper edge. The second inclined sidewall surface adjoins the bottom surface at a second bottom surface edge and adjoins the upper surface at a second upper surface edge. Each of the first and second inclined sidewall surfaces adjoin the bottom surface at an acute angle.

In a method of managing an airway of a patient, the medical support device may be oriented such that the bottom surface of said medical support device is in contact with a level surface such as the ground. The patient may be positioned onto the medical support device in a supine position with the thoracic spine region of the patient resting on the upper surface of the medical support device.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages will be apparent from the following detailed description of the embodiments and the accompanying drawing figures.

### BRIEF DESCRIPTION OF THE DRAWINGS

FIG. 1 is a schematic of a patient's airway alignment in a supine position without use of a medical supporting device;

FIG. 2 is a schematic of a posterior view of a patient;

FIG. 3 is a perspective view of an exemplary embodiment of a medical support device of the present disclosure;

FIG. 4 is an exploded view of the medical support device shown in FIG. 3;

FIG. 5 is a perspective view showing three principal planes intersecting the medical support device shown in FIG. 3;

FIG. 6 is a perspective view of a patient supported by the medical support device shown in FIG. 3, the medical support device orienting the patient in the head-tilt chin-lift position;

FIG. 7 is a perspective view of a base portion;

FIG. 8 is a side view of the base portion shown in FIG. 7;

FIG. 9 is a top view of the base portion shown in FIG. 7;

FIG. 9A is cross-sectional view of the base portion taken along line A-A in FIG. 9;

FIG. 9B is a cross-sectional of the base portion taken along line B-B in FIG. 9;

FIG. 10 is a front view of the base portion shown in FIG. 7;

FIG. 11 is a front view of an exemplary embodiment of a shoulder portion;

FIG. 12 is an exemplary embodiment of a method in accordance with the present disclosure;

FIG. 13 is a perspective view of an alternative exemplary embodiment of a base portion of a medical support device, the perspective view including hidden lines;

FIG. 14 is a perspective view of the alternative exemplary embodiment of the base portion shown in FIG. 13;

FIG. 15 is a perspective view of an alternative exemplary embodiment of a shoulder portion of a medical support device, the perspective view including hidden lines; and

FIG. 16 is a perspective view of the alternative embodiment of the shoulder portion shown in FIG. 15.

Corresponding parts are given corresponding reference characters throughout the drawings.

### DETAILED DESCRIPTION

The following detailed description references the accompanying drawings that illustrate specific embodiments in which the disclosure can be practiced. The embodiments are intended to provide sufficient detail to enable those skilled in the art to practice the present disclosure. Other embodiments can be utilized, and changes can be made without departing from the scope of the disclosure. The following detailed description is, therefore, not to be taken in a limiting sense. The scope of the disclosure is defined only by the claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

Disclosed is a medical device that simplifies and mitigates the challenges known in the field discussed above. It has been recognized that giving consistent patient airway positioning quickly and consistently on a scene of an EMS situation can be critical. A one or two person team can easily position the disclosed medical device beneath an unconscious or non-breathing patient to consistently open the patient's airway. A patient placed on the embodiments of the disclosed device automatically presents with a head tilt chin lift, while lifting and spreading the lungs. Use of the disclosed embodiments greatly improve the efficacy of airway administration, e.g., in the administration of tools such as non rebreather masks and bag valve masks. This provides crucial oxygen administration improvement in a consistent and timely manner; greatly improving patient survival probability rates.

Embodiments herein provide systems and a method for supporting a person during an emergency medical situation. In such situations various patient variables may be present, such as, but not limited to, unconsciousness, body mass, apneic inducing anatomical makeup as well as heavy chest build. While laying supine, conscious or unconscious, the airway structure of many patients may not be open due to many variables, including anatomical structure, airway positioning, and weight. Emergency responders recognize that it is a common problem for patients with sub-optimum airway anatomical structure to be unable to breathe while in a supine position, especially when they are unconscious.

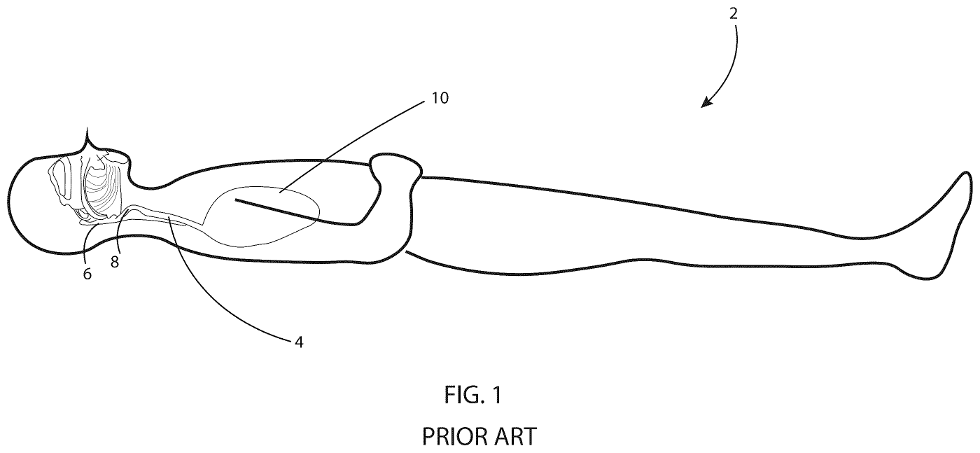

In embodiments, medical support devices consistent with the present teachings facilitate positioning the patient's body in a supine position with their head tilted and their chin lifted. The positioning of the patient on such medical support devices facilitates opening of the patient's airway to increase air flow and improve respiration. In these embodiments, such devices involved positioning the patient to facilitate an open, unobstructed airway to enable emergency medical assistance procedures such as the administration of supplemental oxygen. FIG. 1 shows an exemplary depiction of an airway of a patient lying supine on a flat surface while unconscious. The patient of FIG. 1 has no facilitated head-tilt chin-lift positioning, and it can be seen in the figure that the airway traveling from the pharynx 6 and larynx 8, through the trachea 4, and to the lungs 10 are all narrow, which may result in airway restriction casing insufficient respiration for the patient.

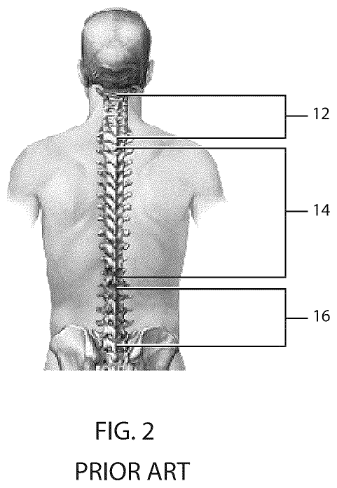

For reference purposes, FIG. 2 depicts a posterior view of a human spine. As those skilled in the art will understand, a human spine comprises a cervical spine region 12, a thoracic spine region 14, and a lumbar spine region 16. Medical support devices consistent with the present teachings may be configured to support the thoracic spine region 14, which includes the thoracic spine along with the muscle and tissue surrounding the thoracic spine.

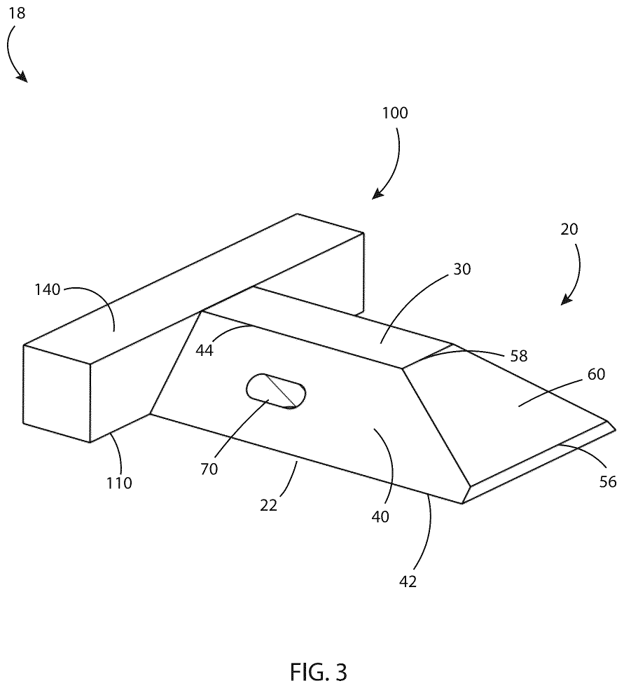

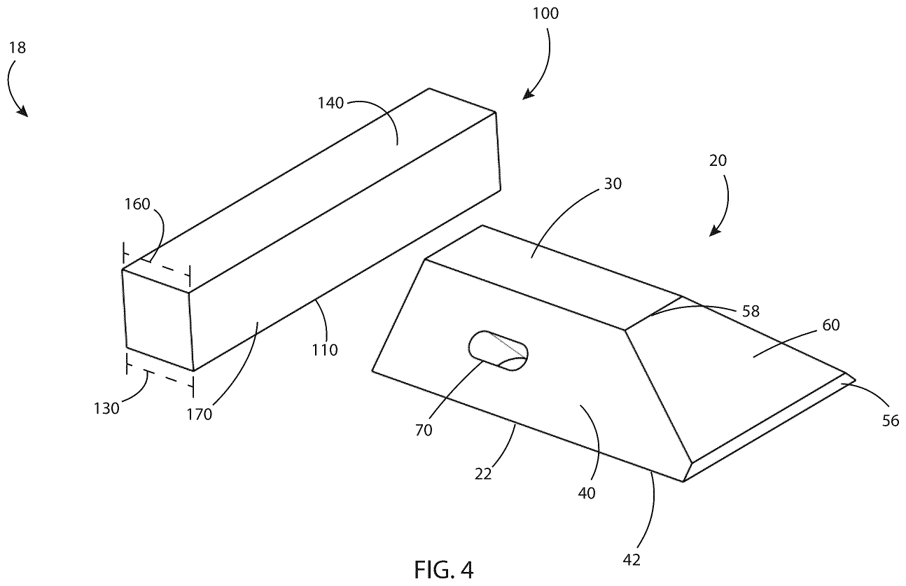

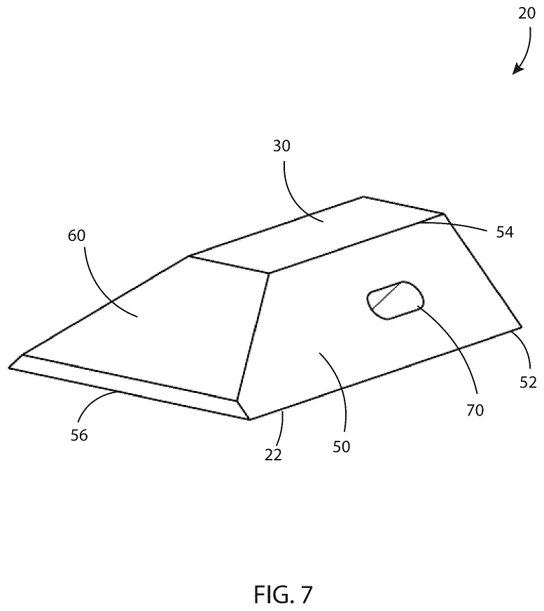

As shown in FIG. 3 and FIG. 4, in one aspect, a medical support device 18 is disclosed. The medical support device 18 includes a base portion 20 and a shoulder portion 100. As depicted, the base portion 20 comprises a bottom surface 22, an upper surface 30, and first and second inclined sidewall surfaces 40 and 50, respectively. (The second inclined sidewall surface 50 is depicted in connection with FIG. 7). The shoulder portion 100 includes a bottom surface 110 and an upper surface 140. Collectively, the bottom surface 22 of the base portion 20 and the bottom surface 110 of the shoulder portion 100 form a bottom surface of the medical support device 18. Similarly, the upper surface 30 of the base portion 20 and the upper surface 140 of the shoulder portion 100 form an upper surface of the medical support device 18. More specifically, the upper surface 30 of the base portion 20 and the upper surface 140 of the shoulder portion 100 form a T-shaped support surface that is configured to support at least a portion of a thoracic spine region 14 and shoulders of a patient.

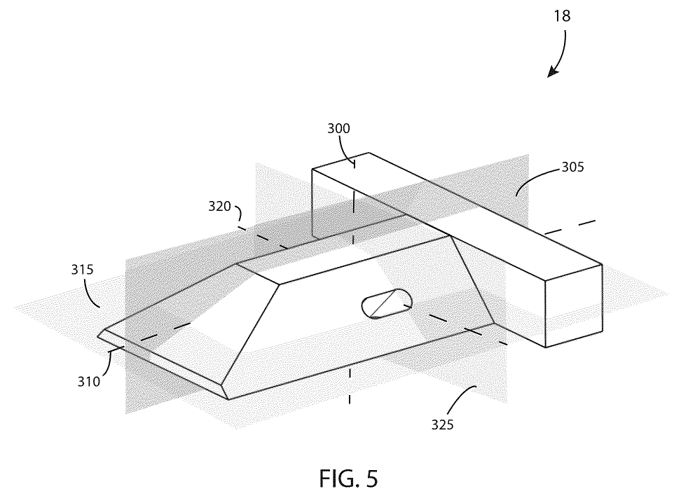

FIG. 5 illustrates an embodiment of the medical support device 18 with reference planes and axes to enable description of various locations of elements of the example medical support device. A person of ordinary skill in the art will recognize that anatomical terms (e.g., sagittal, transverse, and coronal) are used to describe the reference planes and axes because the device of the present disclosure is a medical support device. It should be noted that these are reference planes and axes for the medical support device 18, and the position of said reference planes and axes need not change if a patient is on the medical support device 18. As shown in FIG. 5, the medical device 18 has a sagittal axis 310 located in a median sagittal plane 305, a transverse axis 320 located in a median transverse plan 315, and a coronal axis 300 located in a median coronal plane 325. The median sagittal plane 305 separates the medical support device 18 into first and second portions (broadly, right and left halves). The median transverse plane 315 separates the medical support device 18 into top and bottom portions. More specifically, the median transverse plane 315 separates the medical support device 18 into top and bottom halves. The median coronal plane 325 separates the medical support device 18 into front and rear portions.

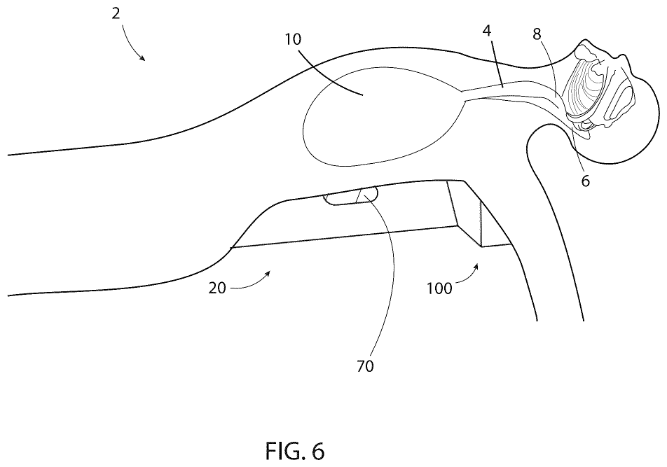

As generally illustrated in FIG. 6, the medical support device 18 is configured to support at least a portion of the thoracic spine region 14 of a patient 2. An effective positioning of the patient atop the medical support device 18 aligns the patient's spine with the sagittal axis 310. Collectively, the first inclined sidewall surface 40, the upper surface 30, and the second inclined sidewall surface 50 orient a chest airway region of a patient 2 into an open position when the patient is lying in a supine position. The medical support device 18 aligns the pharynx 6, larynx 8, trachea 4 and spreads the lobes of the lungs 10 of the patient when they are positioned in a supine position on the device. It should be noted that the airway of the patient (the pharynx 6, larynx 8, trachea 4, and lungs 10) shown in FIG. 6 is expanded significantly compared to the airway of the patient shown in FIG. 1 in which a patient is depicted as lying supine on a flat surface. Alignment of a patient's airway may be especially beneficial for overweight or obese patients because, as one of ordinary skill in the art will understand, obesity increases the size of the upper airway and lower airway soft tissue structures. This in turn constricts the airway of the patient, especially while the patient is lying supine on their back.

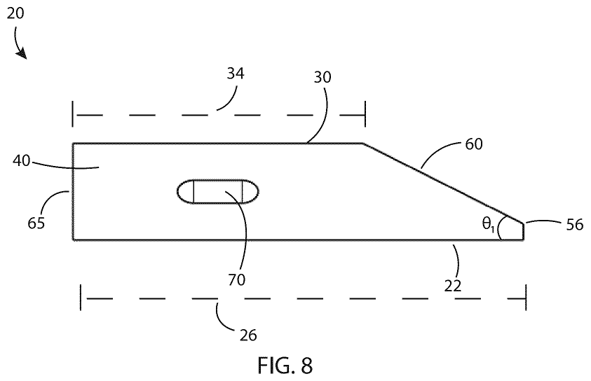

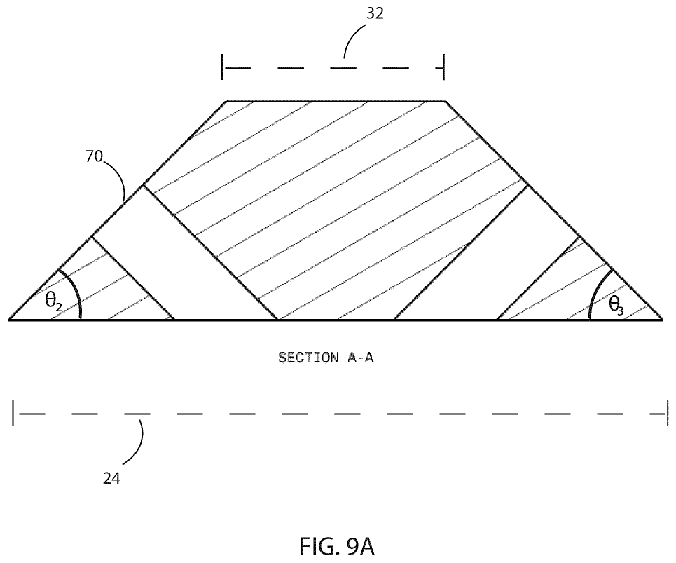

FIGS. 7-10 illustrate an exemplary embodiment of the base portion 20 of the medical support device 18 in which the upper surface 30, the bottom surface 22 and the first and second inclined sidewall surfaces 40, 50 are substantially planar. The first inclined sidewall surface 40 adjoins the bottom surface 22 at a first bottom edge 42 and adjoins the upper surface 30 at a first upper edge 44, and the second inclined sidewall surface 50 adjoins the bottom surface at a second bottom edge 52 and adjoins the upper surface 30 at a second upper edge 54. The upper surface 30 is located transversely between the first and second inclined sidewall surfaces 40, 50. In this embodiment the upper surface 30 and the bottom surface 22 are substantially parallel to the median traverse plane 315. In other embodiments, the surfaces of the base portion 20 may be rounded, bulging, or otherwise non-planar.

The bottom surface 22 of the base portion 20 may be substantially planar so as to be compatible with a substantially level surface such as level ground, a floor, or a bed. The first and second sidewall surfaces 40 and 50, respectively, extend upwardly from the bottom surface 22 to the truncated upper surface 30. A person of ordinary skill in the art will appreciate that the sidewall surfaces may be one continuous surface or multiple surfaces. In an embodiment, the base portion 20 may be a frustrum with multiple sidewall surfaces extending from a bottom surface to a truncated upper surface. In another embodiment, the base portion 20 may be frustoconical with a conical sidewall surface extending from a bottom surface to a truncated upper surface 30 to establish an upper patient-supporting surface.

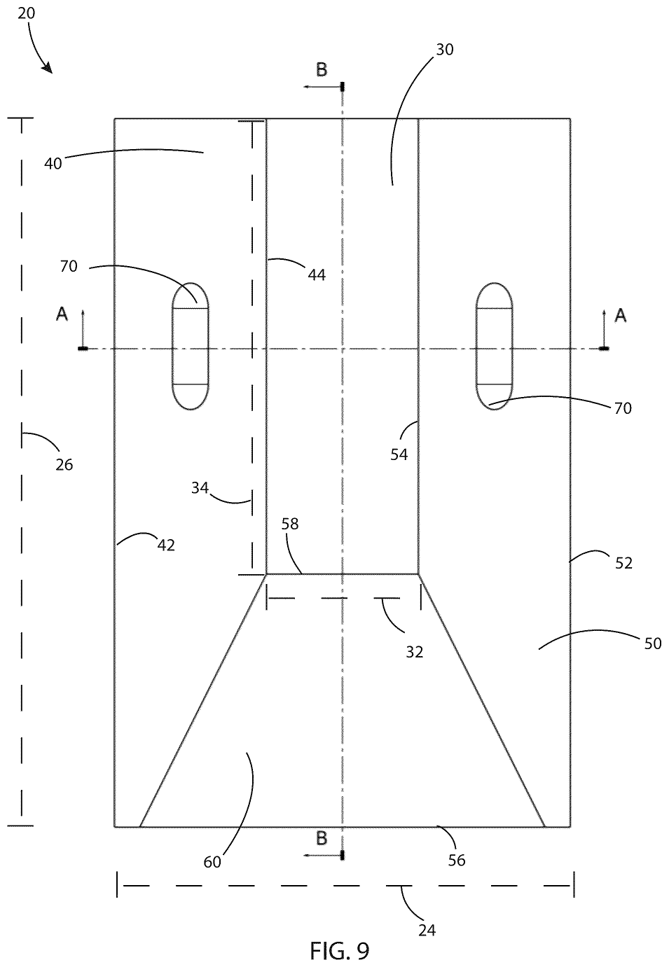

Using the reference planes and axes introduced in FIG. 5, the bottom surface 22 and upper surface 30 of the base portion 20 are located below and above the median transverse plane 315, respectively. The first and second inclined sidewall surfaces 40 and 50 are located transversely (to the left of and to the right of) the median sagittal plane 305. As best seen in FIGS. 9-9B, the bottom surface 22 has a bottom surface width 24 and a bottom surface length 26. In an exemplary embodiment, the bottom surface width 24 is approximately 9 inches, while the bottom surface length 26 is approximately 14 inches. It should be noted that these dimensions are easily adjustable or customizable so that the medical support device 18 can be compatible for use with larger or smaller patients. The bottom surface 22 is configured to be placed in contact with a substantially level surface; however, the bottom surface 22 may be placed on other surface types without departing from the scope of the present disclosure. For example, the bottom surface 22 may be placed on a movable surface such as a patient bed which may not always remain substantially level. It is also possible for the bottom surface 22 of the base portion 20 to be placed on a substantially sloped or curved surface, such as a hill, as long as patient stability is possible. Furthermore, the bottom surface 22 may include a textured or non-slip surface to prevent the base portion 20 from slipping.

As seen in FIGS. 7-10, the upper surface 30 of the base portion 20 is located opposite the bottom surface 22. The upper surface 30 has an upper surface width 32 that is less than an upper surface length 34, as best seen in FIG. 9. The upper surface width 32 is also less than the bottom surface width 24, establishing a wider device footprint to eliminate the tendency of the base portion 20 to tip over from left or right when a patient is being positioned onto the base portion. Although the uppers surface 30 is shown as being planar in FIGS. 7-10, it is envisioned that the upper surface 30 could have a slope or contour to accommodate the thoracic spine region 14 of the patient 2.

In the embodiment shown in FIGS. 7-10, the upper surface length 34 may be less than the bottom surface length 26, creating a sloped front face 60 that adjoins the bottom surface 22 at a third bottom edge 56 and adjoins the upper surface at a third upper edge 58. The front face 60 adjoins the bottom surface 22 at an acute angle θ1. The sloped front face 60 allows the lumbar spine region 16 of a patient to rest upon it during use of the base portion 20, thereby providing additional support to the patient's spine. FIG. 9B shows an embodiment with a first acute angle θ1. Each of the first and second inclined sidewall surfaces 40, 50 adjoin the bottom surface 22 at an acute angle, as seen in the sectional view of the base portion in FIG. 9A. The angles θ2 and θ3 are defined by the relationship of the sidewall surfaces 40, 50 to the bottom surface 22. Angles θ2 and θ3 are acute angles that may fall within an inclusive range of 20° to 80°. A person of ordinary skill will understand that although the upper and bottom edges of the inclined sidewall surfaces are illustrated as “sharp edges” in the figures, the edges may need to be rounded, chamfered, or otherwise modified for manufacturing purposes.

The base portion 20 of the medical support device 18 may further comprise handles 70 extending from each of the sidewall surfaces to the bottom surface 22, as shown in FIG. 9A. In this embodiment, the handles 70 are openings located within the first and second inclined sidewall surfaces 40, 50. It should be understood that these handles may be placed anywhere on the base portion 20 without departing from the scope of the present disclosure. Additionally, other handle shapes and configurations are possible, such as but not limited to carrying handles, D-handles, knobs, and straps.

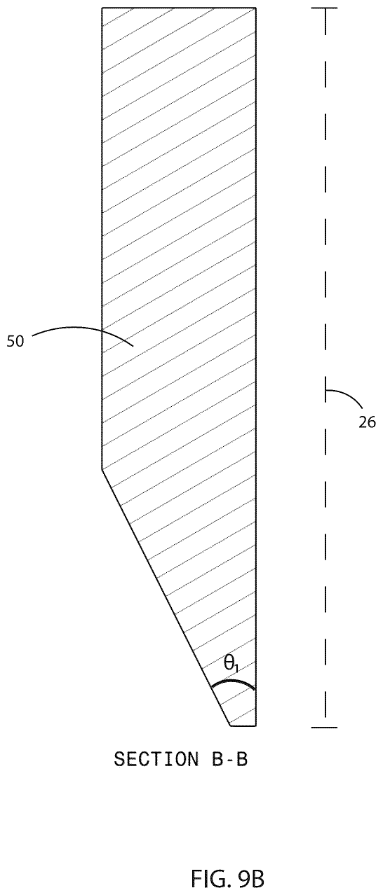

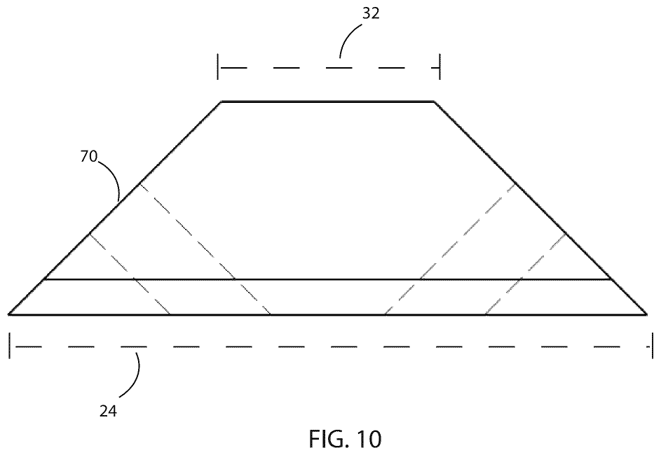

An embodiment of the shoulder portion 100 of the medical support device 18 is best seen in FIGS. 4 and 11. The bottom surface 110 has a bottom surface width 120 and a bottom surface length 130. The upper surface 140 is located opposite the bottom surface 110 and has an upper surface width 150 and an upper surface length 160. The upper surface width 150 is greater than that of the upper surface length 160. Although the upper surface width 150 is shown as being substantially equal to the bottom surface width 120 in FIG. 12, it is contemplated within the scope of the present disclosure that the upper surface width may be less than the bottom surface width such that the sidewalls of the shoulder portion are angled. The angled sidewalls of the shoulder portion may further support the shoulders of the patient as the shoulders slump down towards the ground. In an aspect, the medical support device 18 may be symmetrical about the median sagittal plane, such that the right half and the left half of the device are mirrored and of similar size and shape.

The base portion 20 may further comprise a rear face 65 located on the rear portion of the medical support device 18. In an embodiment, the medical support device 18 further comprises a connection assembly, wherein at least a portion of the connection assembly is located on the rear face 65 of the base portion 20, and wherein at least a portion of the connection assembly is located on a front face 170 of the shoulder portion 100. In an embodiment, the connection assembly is a hook and loop connection assembly, wherein the hook is located on the shoulder portion 100 and the loop is located on the base portion 20. Alternatively, the hook may be located on the rear face 65 of the base portion 20 while the loop is located on the shoulder portion 100. Other types of connection assemblies may be used without departing from the spirit and scope of the present disclosure, such as, but not limited to, Velcro systems, pins, a latch, mechanical fasteners, or any other means for removable connection. It is also within the scope of the present disclosure for the shoulder portion 100 to be permanently connected to the base portion 20, or the base portion 20 to be used alone.

In the context of the present disclosure, “removably attached” means that the shoulder portion 100 may be temporarily attached and removed from the base portion 20. The ability to removably attach the shoulder portion 100 and the base portion 20, makes it possible to fit the device into a medical bag or confined space, such as an ambulance. To further enable convenient storage options, a second connection assembly may be attached to either of the inclined sidewall surfaces 40, 50, the front face 60, or the bottom surface 22 of the base portion 20 to removably attach the shoulder portion 100. Once the base portion 20 and the shoulder portion 100 have been separated, the shoulder portion may be attached to an inclined sidewall surface 40, 50, the front face 60, or the bottom surface 22 for storage.

Although a variety of material systems can be used, the medical support device 18 is preferably composed of a flexible supportive material such as foam. One example of such a material is a polymer foam, and more specifically, a closed-cell polymer foam. Utilizing closed-cell polymer foam for the device minimizes manufacturing costs and the weight of the device while enabling medical-grade sanitization to occur. In one embodiment, the medical support device 18 is comprised of an MC1900 material, which is a cross-linked polyethylene foam. A separate pad may be placed onto the medical support device 18 to provide additional cushioning for the patient.

The medical support device 18 may optionally include a covering for the base and/or shoulder portion. The covering may be constructed of a non-porous material, and further is capable of withstanding medical grade sanitization. In some embodiments the covering is removable. Other methods of covering or sealing the device may be used without departing from the scope of the present disclosure, including disposable single-use coverings. In another embodiment, the covering is a polymer coating which is a waterproof or nonporous material.

The flowchart shown in FIG. 12 shows a method of managing an airway of a patient 500 using the medical support device 18. The method includes placing a medical support device 18 on a substantially level surface (step 510) and orienting the device such that the bottom surface is in contact with the substantially level surface (step 520). The patient can then be positioned onto the medical support device 18 in a supine position such that a thoracic spine region 14 of the patient 2 rests on the upper surface 30 of the medical support device 18 (step 530). The acute angles of the inclined sidewall surfaces enable a trained professional to more easily place the patient onto the medical device without the need for additional team members. One method of placing the patient onto the medical device is using the inclined sidewall surface of the base portion as a wedge. The patient can be rolled onto their side and the body portion wedged underneath the shoulder of the patient. The inclination of the sidewall surface makes it easier for the trained professional to slide the patient more fully onto the upper surface as the patient is rolled onto their back.

Once the patient 2 is positioned, the device supports the patient to open the airway of the patient 2. The open airway position of the patient 2 is conducive for air movement and oxygen administration, it is also an optimal position for a trained user to administer CPR or perform an intubation procedure. The shoulder portion 100 under a patient receiving CPR may help prevent the patient from rocking or shifting on the medical support device 18. Once into position on the medical support device 18, the patient 2 is elevated in the thoracic spine region 14 and the patient's head is tilted and the chin lifted, which is an optimal open airway position. In this position, patient respiration is ideal and the patient is well positioned to receive medical treatment, for example, oxygen administration such as but not limited to, non-rebreather mask oxygen administration, bag valve mask oxygen administration, as well as intubation and CPR.

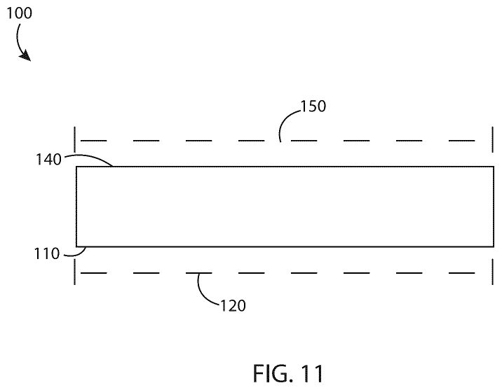

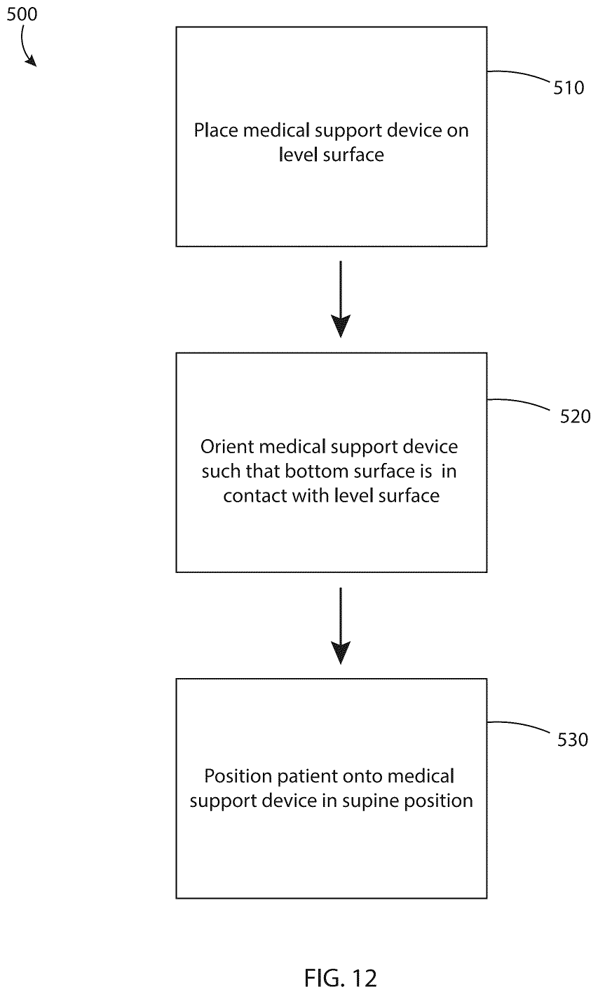

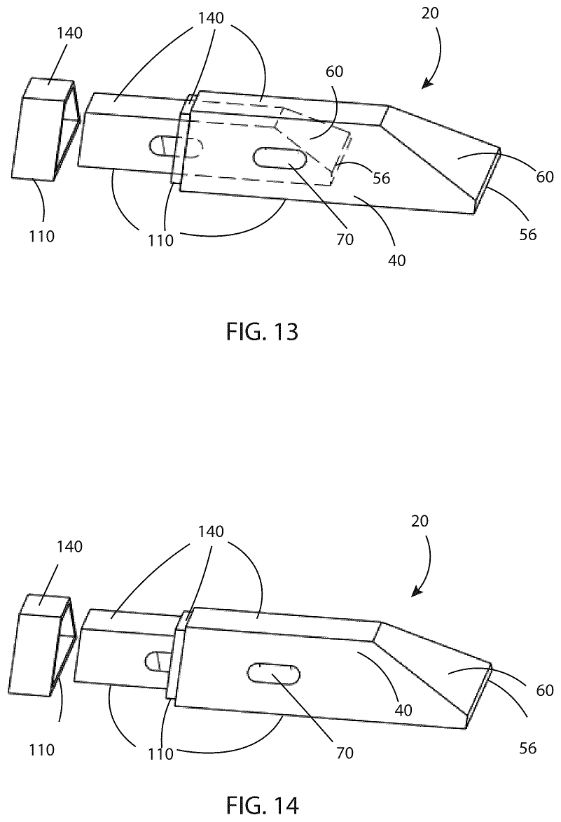

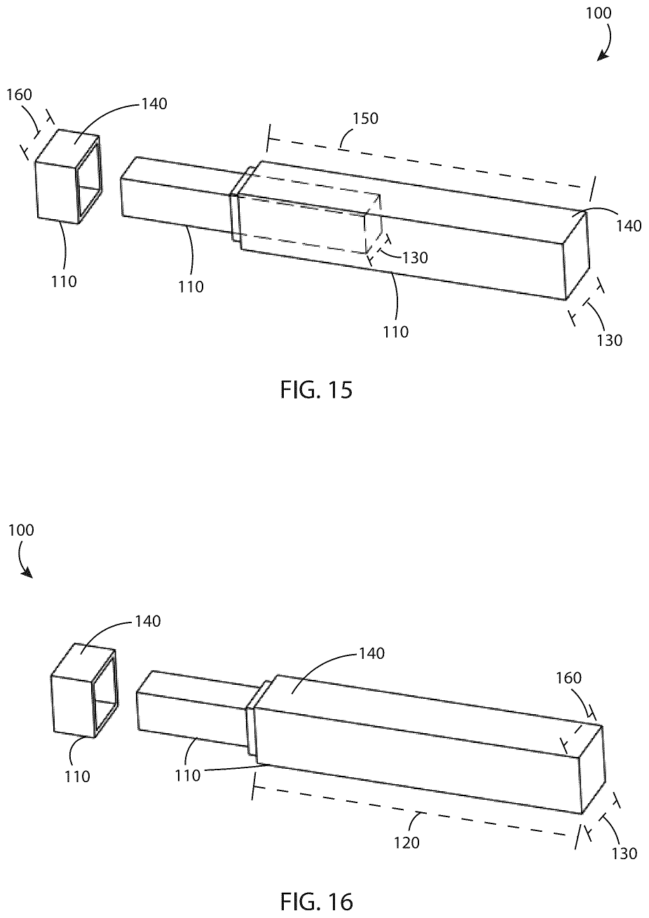

Smaller, larger, expandable and/or collapsible versions of the medical support device 18 are possible. FIGS. 13-16 provide an exemplary embodiment of a size-adjustable medical support device 18 in accordance with the present disclosure. FIGS. 13 and 14 show a smaller scale medical support device 18 housed within a larger medical support device 18. More specifically, the medical support device 18 has a modular nature which enables a user to remove a portion of the base portion in order to remove the smaller scale device. Similarly, FIGS. 15 and 16 show a shoulder portion 100 with a similar modular nature, which enables a user to remove a portion of the shoulder portion 100 in order to remove the smaller scale shoulder portion 100. Each of the base and shoulder portions with smaller dimensions comprise their own connection assemblies which enable their use within a full medical support device 18 of any size. The phenomenon shown in FIGS. 13-16 may be broadly referred to as the “nesting feature”. The nesting feature may be used to nest multiple devices of similar shape and smaller size. The smaller scale medical support devices could be used to support pediatric and infant patients.

It should be noted, however, that other adjustable or modular embodiments may be used without departing from the scope of the present disclosure. For example, a slidable mechanism may be used to expand or contract the shoulder portion and base portions to adjust the size of each. In another example, an inflatable structure may be used such that the medical support device 18 is stored at a minimum uninflated size, such that it is configured to be placed under a thoracic spine region 14 of a patient 2 and inflated to the size that specific patient requires. In yet another example, the medical support device 18 is foldable and/or detachable along each edge such that the medical support device may collapse into a flat storage configuration or be easily disassembled.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved, and other advantageous results attained.

As various changes could be made in the above products and methods without departing from the scope of the disclosure, it is intended that all matter contained in the above description shall be interpreted as illustrative and not in a limiting sense.

The invention claimed is:

1. A medical support device comprising:
a bottom surface configured to support the device; and
a sidewall surface extending upwardly from the bottom surface to a truncated upper surface, the truncated upper surface establishing an upper patient-supporting surface,
wherein the sidewall surface is configured to orient a chest airway region of a patient into an open position when the patient is oriented in a supine position with the upper surface of the medical support device positioned beneath a thoracic spine region of the patient.

2. A medical support device for airway management, the medical support device comprising:
a sagittal axis located within a median sagittal plane;
a transverse axis located within a median transverse plane; and
a base portion, the base portion comprising:
a bottom surface, the bottom surface having a bottom surface width and a bottom surface length;
an upper surface, the upper surface being opposite the bottom surface, the upper surface having an upper surface width and an upper surface length, the upper surface width being less than the bottom surface width, the upper surface width being less than the upper surface length; and
first and second inclined sidewall surfaces, the first inclined sidewall surface adjoining the bottom surface at a first bottom edge and adjoining the upper surface at a first upper edge, the second inclined sidewall surface adjoining the bottom surface at a second bottom edge and adjoining the upper surface at a second upper edge, the upper surface being located transversely between the first and second inclined sidewall surfaces; and
wherein the first inclined sidewall surface, the upper surface, and the second inclined sidewall surface are collectively configured to orient a chest airway region of a patient into an open position when said patient is oriented in a supine position with the upper surface of the medical device positioned beneath a thoracic spine region of said patient.

3. The medical support device of claim 2, wherein the upper surface length is less than the bottom surface length.

4. The medical support device of claim 3, wherein the base portion is symmetrical about the median sagittal plane.

5. The medical support device of claim 4, wherein each of the first and second inclined sidewall surfaces adjoin the bottom surface at an acute angle.

6. The medical support device of claim 5, wherein the base portion further comprises a front face, the front face adjoining the bottom surface at a third bottom edge and adjoining the upper surface at a third upper edge.

7. The medical support device of claim 6, wherein the front face adjoins the bottom surface at an acute angle.

8. The medical support device of claim 7, wherein the acute angle between the front face and the bottom surface is a first acute angle, the acute angle between the first inclined sidewall surface and the bottom surface is a second acute angle, and the acute angle between the second inclined surface and the bottom surface is a third acute angle, the first acute angle being less than the second and third acute angles.

9. The medical support device of claim 2, wherein the base portion further comprises a handle opening, the handle opening being located within the first inclined sidewall surface.

10. The medical support device of claim 9, wherein the handle opening extends from the first sidewall surface to the bottom surface.

11. The medical support device of claim 2, wherein each of the upper surface, the bottom surface, and the first and second inclined sidewall surfaces are substantially planar.

12. The medical support device of claim 2, wherein the base portion is comprised of a polymer foam.

13. The medical support device of claim 12, wherein the polymer foam is a closed cell polymer foam.

14. The medical support device of claim 12, wherein the medical support device further comprises a covering encompassing the base portion, the covering being made of a non-porous material.

15. The medical support device of claim 2, further comprising:
a shoulder portion, the shoulder portion comprising:
a bottom surface, the bottom surface having a bottom surface width and a bottom surface length; and
an upper surface, the upper surface being opposite the bottom surface, the upper surface having an upper surface width and an upper surface length, the upper surface width being greater than the upper surface length;
wherein the upper surface of the base portion and the upper surface of the shoulder portion collectively form a T-shaped support surface.

16. The medical support device of claim 15, wherein the base portion and the shoulder portion are symmetrical about the median sagittal plane.

17. The medical support device of claim 16, wherein each of the first and second inclined sidewall surfaces adjoin the bottom surface at an acute angle.

18. The medical support device of claim 17, wherein the base portion further comprises a front face, the front face adjoining the bottom surface at a third bottom edge and adjoining the upper surface at a third upper edge.

19. The medical support device of claim 18, wherein the front face adjoins the bottom surface at an acute angle.

20. A method of managing an airway of a patient, the method comprising:
placing a medical support device on a substantially level surface, the medical support device comprising a base portion, the base portion having a bottom surface, an upper surface opposite the bottom surface, and first and second inclined sidewall surfaces, the bottom surface having a bottom surface width and the upper surface having an upper surface width, the upper surface width being less than the bottom surface width, the first inclined sidewall surface adjoining the bottom surface at a first bottom edge and adjoining the upper surface at a first upper edge, the second inclined sidewall surface adjoining the bottom surface at a second bottom surface edge and adjoining the upper surface at a second upper surface edge, each of the first and second inclined sidewall surfaces adjoining the bottom surface at an acute angle;
orienting the medical support device such that the bottom surface of said support device is in contact with the substantially level surface; and
positioning the patient onto the medical support device in a supine position, the patient being positioned such that a thoracic spine region of said patient rests on the upper surface of the medical support device.
